(19) United States
(12) Patent Application Publication
(10) Pub. No.: US 2023/0229756 A1
(43) Pub. Date: Jul. 20, 2023

(54) RAPID LAUNCH OF SECURE EXECUTABLES IN A VIRTUALIZED ENVIRONMENT

(71) Applicant: VMWARE, INC., Palo Alto, CA (US)

(72) Inventors: VASANTHA KUMAR DHANASEKAR, Pune (IN); Shirish Vijayvargiya, Pune (IN); Bharath Kumar Chandrasekhar, Sunnyvale, CA (US); Leena Shuklendu Soman, Pune (IN)

(21) Appl. No.: 17/701,736

(22) Filed: Mar. 23, 2022

(30) Foreign Application Priority Data
Jan. 18, 2022 (IN) 202241002866

(51) Int. Cl. G06F 21/51; H04L 9/32; G06F 9/455

(52) U.S. Cl. CPC G06F 21/51; H04L 9/3239; G06F 9/45558; G06F 2221/033; G06F 2009/45562; G06F 2009/45587

(57) ABSTRACT

Rapid launch of secure executables in a virtualized environment includes using a persisted security cache in a virtualized component (VC), such as a virtual machine. The VC generates a cache integrity value (IV), such as a hash value, for the security cache and sends it to a remote validator, which returns an indication of security cache validity or invalidity. Upon receiving a request to execute applications, the VC analyzes whether the applications have been determined to be safe to execute and have not been altered. The VC retrieves application IVs from the security cache, rather than hashing each of the applications, thereby saving compute time, and sends the application IVs to a remote validator, which returns an indication of application validity or invalidity.

### RELATED APPLICATION

Benefit is claimed under 35 U.S.C. 119(a)-(d) to Foreign Application Serial No. 202241002866 filed in India entitled “RAPID LAUNCH OF SECURE EXECUTABLES IN A VIRTUALIZED ENVIRONMENT”, on Jan. 18, 2022, by VMware, Inc., which is herein incorporated in its entirety by reference for all purposes.

### BACKGROUND

Some antivirus software systems attempt to anticipate and prevent both known and unknown threats. For example, some systems use safelisting of known safe software applications in which, before an application is executed, a hash value of the application is sent to a remote validation server. The remote validation server looks up the hash value and, if found, returns an indication of a valid result. The hash value is calculated the first time each application is launched. In a large-scale virtualized environment in which hundreds of clone virtual machines (VMs) are spawned and launched simultaneously, each VM is executing for the first time. Thus, when each VM executes applications after launch, the hash values of each application must be calculated. When hundreds of VMs are involved, this may create a noticeable delay in launching executable applications.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide for rapid launch of secure executables in a virtualized environment. Example operations include: retrieving, by a virtualized component (VC), a persisted security cache; generating, for the security cache, a cache integrity value (IV); sending, to a remote cache validator, the cache IV and a VC identifier associated with the security cache; receiving, from the remote cache validator, an indication of security cache validity; receiving a request to execute a first application on the VC; based on at least receiving the request to execute the first application and receiving the indication of security cache validity, retrieving, from the security cache, a first application IV for the first application; sending, to a remote application validator, the first application IV; receiving, from the remote application validator, an indication of validity for the first application or an indication of invalidity for the first application; and based on at least receiving the indication of validity for the first application, permitting the first application to execute on the VC, or based on at least receiving the indication of invalidity for the first application, blocking the first application from executing on the VC.

### BRIEF DESCRIPTION OF THE DRAWINGS

The present description will be better understood from the following detailed description read in the light of the accompanying drawings, wherein:

FIG. 1 illustrates an example architecture that advantageously provides for rapid launch of secure executables in a virtualized environment;

FIG. 2 shows a message sequence diagram of exemplary messages that may occur in the architecture of FIG. 1;

FIG. 3 illustrates a flowchart of exemplary operations associated with examples of the architecture of FIG. 1, and which references the flowcharts in FIGS. 4-8;

FIG. 4 illustrates a flowchart of exemplary operations that may be performed in conjunction with the flowchart of FIG. 3;

FIG. 5 illustrates another flowchart of exemplary operations that may be performed in conjunction with the flowchart of FIG. 3;

FIG. 6 illustrates another flowchart of exemplary operations that may be performed in conjunction with the flowchart of FIG. 3;

FIG. 7 illustrates another flowchart of exemplary operations that may be performed in conjunction with the flowchart of FIG. 3;

FIG. 8 illustrates another flowchart of exemplary operations that may be performed in conjunction with the flowchart of FIG. 3;

FIG. 9 illustrates exemplary operations associated with examples of the architecture of FIG. 1; and

FIG. 10 illustrates a block diagram of a computing apparatus that may be used as a component of the architecture of FIG. 1, according to an example.

### DETAILED DESCRIPTION

Rapid launch of secure executables in a virtualized environment includes using a persisted security cache in a virtualized component (VC), such as a virtual machine (VM) or container. The VC generates a cache integrity value (IV) (e.g., a hash value or checksum) for the security cache and sends it to a remote validator, which returns an indication of security cache validity or invalidity. Upon receiving a request to execute applications, the VC determines whether the applications are safe to execute and have not been altered. To do so, the VC retrieves application IVs from the security cache, rather than needing to hash each of the applications (thereby saving compute time), and sends the application IVs to a remote validator. The remote validator returns an indication of application validity (e.g., safelisted) or invalidity. In some examples, a secure hash algorithm (SHA) family hash function is used, and the hash value is a SHA-256 hash value.

Example operations for launching secure executables include retrieving, by a virtualized component, a persisted security cache. A cache IV is generating for the security cache and sent to a remote cache validator along with a VC identifier associated with the security cache. An indication of security cache validity is received from the remote cache validator. A request to execute a first application on the VC is received. Based on at least receiving the request to execute the first application and receiving the indication of security cache validity, a first application IV for the first application is retrieved from the security cache. The first application IV is sent to a remote application validator. An indication of validity or invalidity for the first application is received from the remote application validator. If the indication of validity is received, the first application is permitted to execute on the VC. If the indication of invalidity is received, the first application is blocked from executing on the VC.

Leveraging a validated, persisted cache of computed IVs for applications permits improvements in the speed of computing operations when launching or deploying VMs (and/or other virtualized executables, such as containers), especially when launching large quantities (e.g., hundreds) of VMs. This is accomplished at least by: based on at least receiving the request to execute an application and receiving the indication of security cache validity, retrieving, from the security cache, an application IV for the application (e.g., rather than re-computing the application IV). The validation of the security cache itself guards against a security threat of potential modification of the security cache, such as by a hacker who modifies the application to include malicious logic and also tampers with the security cache to conceal the modified application's malicious logic from detection.

An example implementation detects offline modification of virtual machine disks (VMDKs), and performs integrity verification of an in-guest hash persisted cache. These two operations may be performed in sequence, in some embodiments. For example, integrity verification is performed after indication of offline modification.

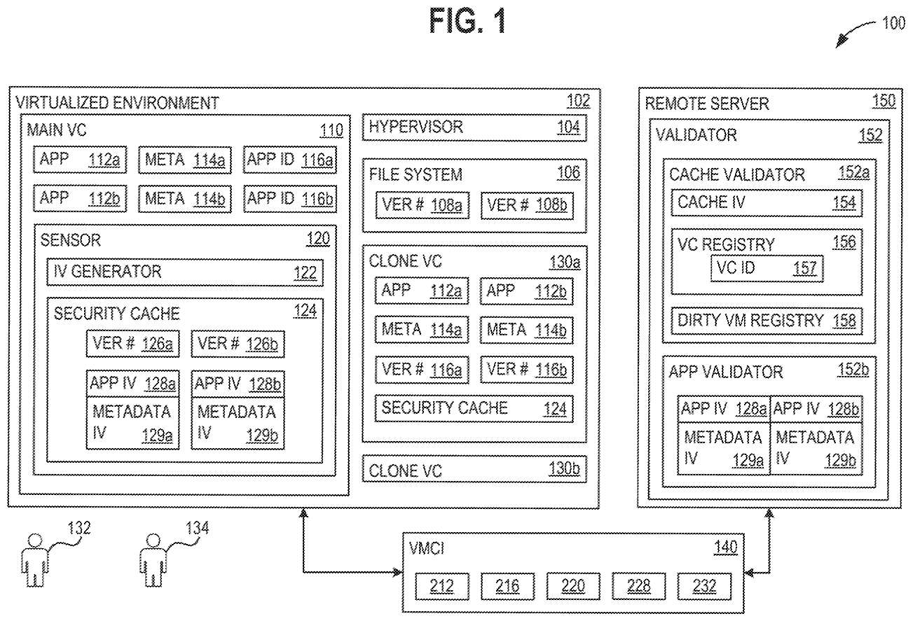

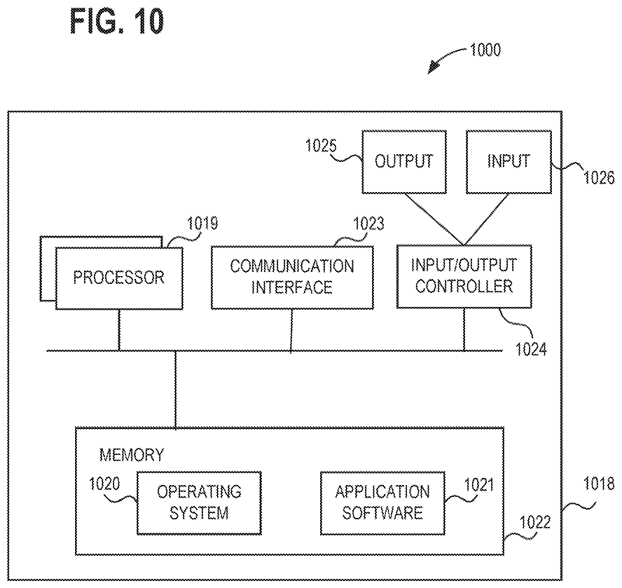

FIG. 1 illustrates an architecture 100 that advantageously provides for rapid launch of secure executables (e.g., a VC 130a and a VC 130b) in a virtualized environment 102. In some examples, architecture 100 is implemented using a virtualization architecture, which may be implemented on one or more computing apparatus 1018 of FIG. 10. An example computing framework on which the components of FIG. 1 may be implemented and executed uses a combination of virtual machines, containers, and serverless computing abstractions. In some examples, virtualized environment 102 provides a virtual desktop infrastructure (VDI) that uses VMs to provide and manage virtual desktops and deploys them for use by a user 134. VC 130a and VC 130b may be VMs, containers, or another type of virtualized component (e.g., a virtualized computing instance).

Virtualized environment 102 deploys VC 130a and VC 130b, indicated as clones of a main VC 110, under the management of a hypervisor 104. A main VC (e.g., golden VM) is a base object that provides a template for clones, such as clone VMs. In some examples, main VC 110, VC 130a, and VC 130b are stored in VMDK files. A journaling file system 106 is used that tracks file version numbers, such as a file version number 108a for an application 112a and a file version number 108b for an application 112b. VC 130a and VC 130b each also have associated metadata (e.g., file path and/or attributes), metadata 114a and metadata 114b, respectively. In some examples, VC 130a and VC 130b each also have associated application identifiers (IDs), app ID 116a and app ID 116b, respectively.

An administrator 132 creates main VC 110, and installs an operating system (OS), applications 112a and 112b (e.g., office and productivity software), and a sensor 120. A next-generation antivirus solution is used to ensure that applications 112a and 112b are safe to execute (e.g., do not contain malware), and has multiple parts. Sensor 120 runs on each endpoint (e.g., main VC 110, VC 130a, and VC 130b), and a validator 152 (“host”) runs on a remote server 150 (e.g., in a cloud resource). Sensor 120 identifies whether application 112a or 112b is about to be executed. If so, it checks a security cache 124 (in memory) for whether an application IV (e.g., an application IV 128a for application 112a or an application IV 128a for application 112a) and metadata (e.g., a metadata IV 129a for metadata 114a or a metadata IV 129b for metadata 114b) exist. If so, it retrieves the application IV and file version number (a file version number 126a for application 112a or a file version number 126b for application 112b) and also loads the file version number from file system 106.

In some examples, the components and data identified as residing on remote server 150 (e.g., validator 152 and its components and data) may be implemented in virtualized environment 102, under the control of hypervisor 104. That is, main VC 110, clone VC 130a, clone VC 130b, and remote server 150 (running as a virtualized server) may all execute in virtualized environment 102 under the control of hypervisor 104, in some examples.

The file version number is correct if file version number 126a matches file version number 108a for application 112a, or file version number 126b matches file version number 108b for application 112b. If the file version number is not correct, the application IV and the metadata IV for the application is discarded. If the application IV value is not already in security cache 124, or has been discarded, sensor 120 generates a new application IV (e.g., hashes the application) and a new metadata IV using an IV generator 122 and saves the IVs and file version number (from file system 106) to security cache 124. At this point, sensor 120 has the IV(s)—either by retrieving it (them) from security cache 124 or calculating it (them). Sensor 120 then performs a cloud reputation check on the application with validator 152. A verdict from validator 152 determines whether sensor 120 will permit the application to execute or block it from executing.

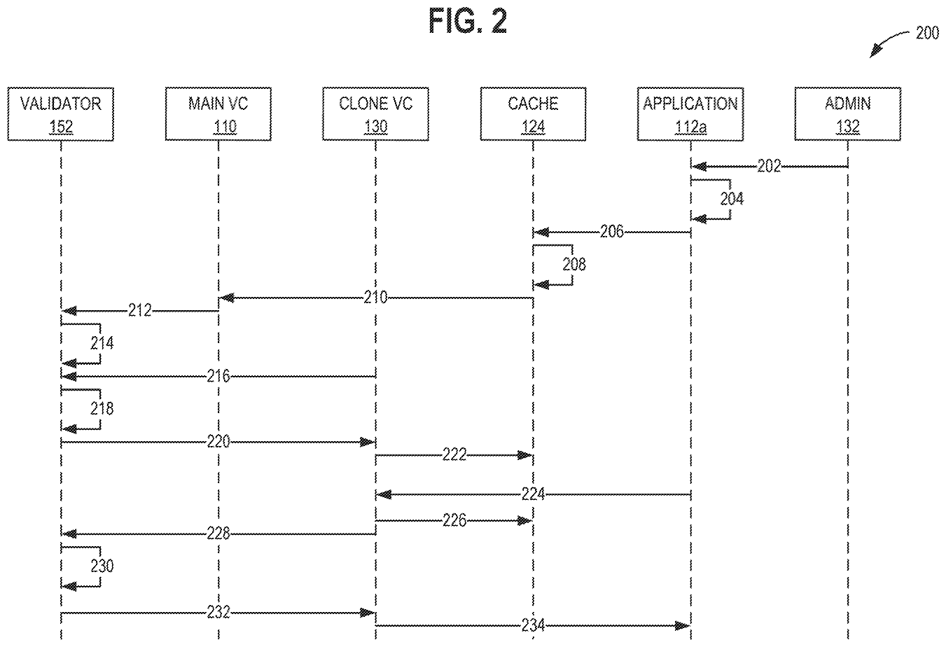

VC 130a and VC 130b are clones of main VC 110 and thus have all of the same file contents (including applications 112a and 112b, metadata 114a and 114b, sensor 120, and security cache 124). In some examples, virtualized environment 102 communicates with validator 152 using a virtual machine communication interface (VMCI) 140. Messages 212, 216, 220, 228, and 232, shown within VMCI 140, are described in relation to FIG. 2.

Validator 152 is illustrated as comprising two parts: a cache validator 152a and an application validator 152b. In some examples, cache validator 152a and application validator 152b operate separately. In some examples, cache validator 152a and application validator 152b are implemented as a single component: validator 152. Validator 152 responds to queries by sensor 120, for example providing a verdict of valid or invalid, based on whether the IVs received from sensor 120 match IVs stored by validator 152.

Cache validator 152a provides validation services for security cache 124, to protect security cache 124 from tampering. To accomplish this, cache validator 152a stores a cache IV 154, which is an IV (e.g., hash value or checksum) of security cache 124. Cache validator 152a also maintains a registry 156 of registered VCs, such as main VC 110. A VC identifier 157 is shown within registry 156, and provides a unique identifier for main VC 110. In some examples, VC identifier 157 comprises a universally unique identifier (UUID), and in some examples, is 128-bits long. Cache validator 152a monitors the status of VC files (e.g., persisted copies of main VC 110) during storage. In the event of an update to a VC file, cache validator 152a makes a record in a dirty VM registry 158 (e.g., copies the VC identifier to dirty VM registry 158). In some examples, VC files are stored encrypted, further preventing tampering.

Application validator 152b provides validation services for applications 112a and 112b, to protect applications 112a and 112b from tampering. To accomplish this, application validator 152b stores application IV 128a, metadata IV 129a, application IV 128b, and metadata IV 129b. Cache validator 152a also maintains a registry 156 of registered VCs, such as main VC 110. A VC identifier 157 is shown within registry 156, and provides a unique identifier for main VC 110. In some examples, VC identifier 157 comprises a universally unique identifier (UUID), and in some examples is 128-bits long. Cache validator 152a monitors the status of VC files (e.g., persisted copies of main VC 110) during storage. In the event of an update to a VC file, cache validator 152a makes a record in a dirty VM registry 158 (e.g., copies the VC identifier to dirty VM registry 158). In some examples, VC files are stored encrypted, further preventing tampering.

Sensor 120 tracks file IV information in security cache 124 as well as stream context, from early boot up until the system shutdown. IV information is also flushed when the file content is about to be overwritten on pre-write filter callback. This results in the file stream context having the consistent file content IV at any point of time when sensor 120 is enabled. Some operating systems employ a mini-filter framework that provides callbacks on pre/post-write, pre/post-read, and close callbacks on files using which anti-virus (AV) solutions are able to intercept file operations. In addition, per file stream context data structure is provided to store file related meta-data information so that it may be accessed across various callbacks.

When shutdown is initiated for a VC, the OS kernel closes the file handles. It will in turn trigger releasing the stream context, indicating that no further file operation is pending on the file. Until this time, the file IV information may be synced with the in-memory file record cache. Upon a shutdown event, there will be no more file operations that can be performed, so the file IVs, in addition to other file attribute information, may be persisted. On boot up, the stored file information may be restored so that there is no need to recalculate the IV on the next boot up.

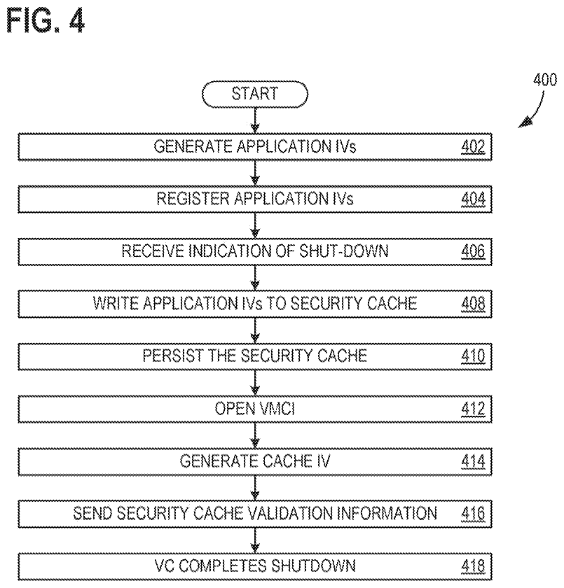

FIG. 2 shows a message sequence diagram 200 of messages that may occur in examples of architecture 100. The messages shown in FIG. 2 are described in conjunction with matching operations in the flowcharts of FIGS. 4-8.

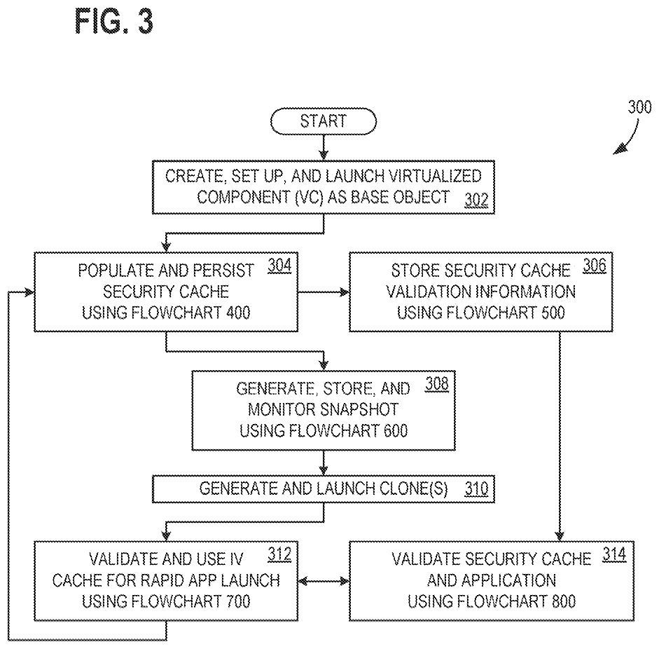

FIG. 3 illustrates a flowchart 300 of exemplary operations associated with architecture 100. In some examples, the operations of flowchart 300 are performed by one or more computing apparatus 1018 of FIG. 10. Flowchart 300 commences with the creation and setup of main VC 110 (e.g., a base object planned for cloning into VCs 130a and 130b) in operation 302. Administrator 132 creates main VC 110 and installs an OS, applications 112a and 112b, and sensor 120, archives the file version number for each application. Administrator 132 then starts execution of main VC 110.

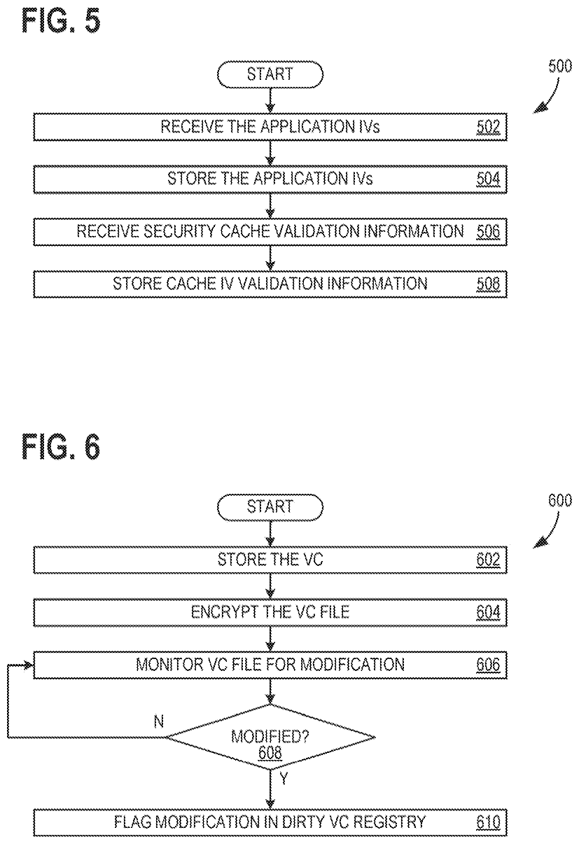

Operation 304 populates and persists security cache 124, using flowchart 400 of FIG. 4. Operation 306 stores cache IV 154 and VC identifier 157 IV as security cache validation information, using flowchart 500 of FIG. 5. Operation 308 generates, stores, and monitors a snapshot of main VC 110 (e.g., the VC file for main VC 110), using flowchart 600 of FIG. 6. User 134 (e.g., a VDI user) logs in, generates clones VC 130a and 130b, and starts executing VC 130a and 130b in operation 310.

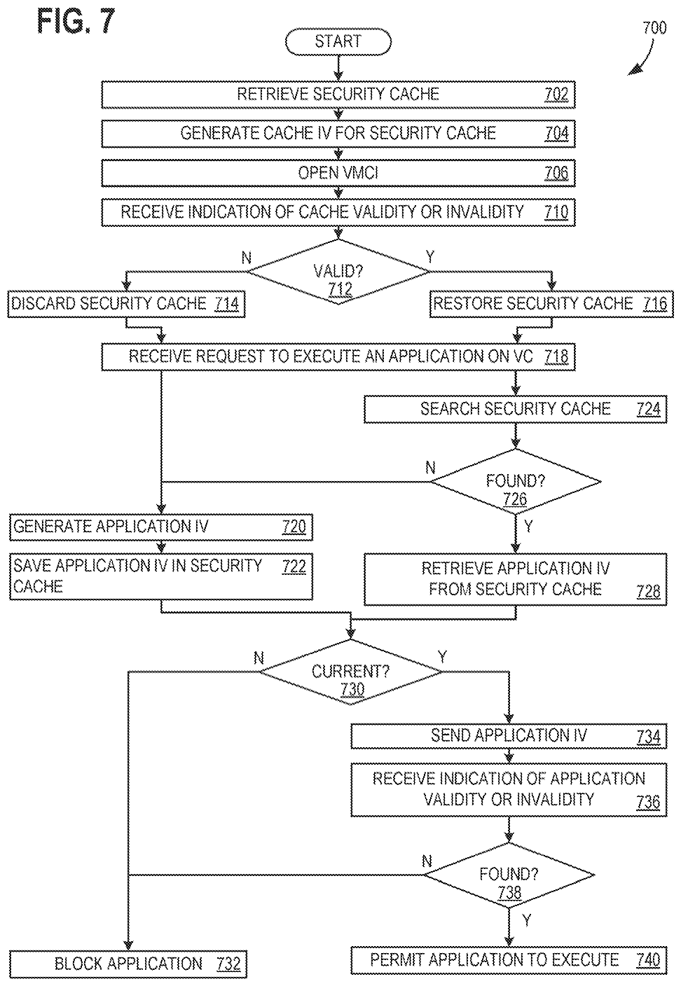

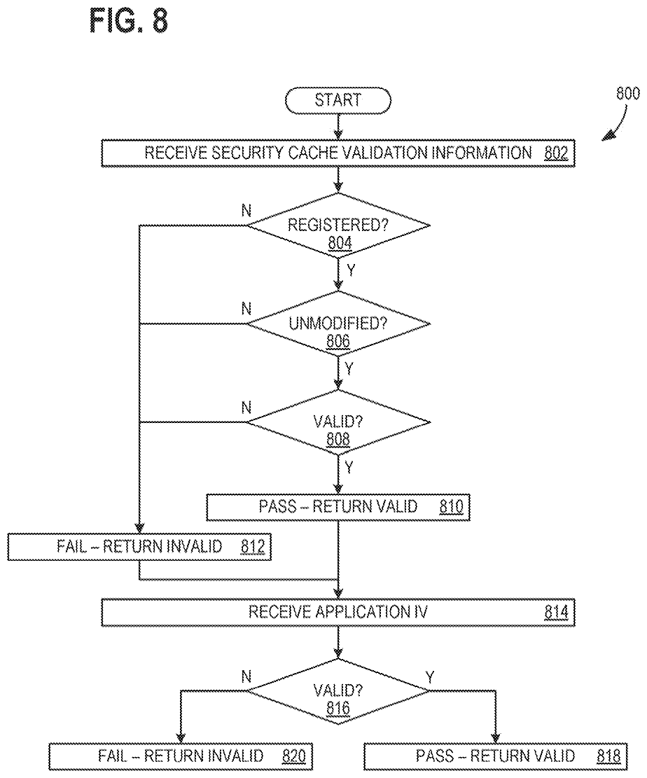

Operations 312 and 314 are concurrent. Operation 312 validates (by sensor 120) and uses security cache 124 to rapidly launch applications 112a and 112b (in relation to generating IVs anew), using flowchart 700 of FIG. 7. Operation 314 validates (by validator 152) security cache 124 and applications 112a and 112b, using flowchart 800 of FIG. 8. When VC 130a or 130b shuts down, flowchart 300 returns to operation 304, although this time to save a copy of security cache 124 in VC 130a or 130b.

FIG. 4 illustrates a flowchart 400 of exemplary operations associated with flowchart 300. In some examples, the operations of flowchart 400 are performed by one or more computing apparatus 1018 of FIG. 10. Flowchart 400 commences with operation 402, which includes generating application IV 128a for application 112a, generating application IV 128b for application 112b, or generating other IVs for other applications. In some examples, the IVs comprise hash values, such as SHA-256 or another hash value. In some examples, the IVs comprise checksum values. In some examples, generating application IV 128a for application 112a further comprises generating metadata IV 129a for metadata 114a of application 112a or generating metadata IV 129b for metadata 114b of application 112b. In some examples, generating an application IV comprises generating a single IV using a concatenated combination of both the application file (VC file) and the metadata for the application. In some examples, generating an application IV comprises generating two IVs, in which a first IV is generated for the application file only and a second IV is generated for the metadata for the application. In some examples, the metadata for the application comprises a path of an executable file of the application. In some examples, the metadata for the application comprises attributes of the executable file of the application.

Operation 404 includes registering, with remote application validator 152b, application IV 128a for application 112a and application IV 128b for application 112b. The application begins shutting down in operation 406. The indication of shutdown is received as message 202 of FIG. 2, and message 204 is the application unloading from memory. Operation 408 includes writing application IV 128a to security cache 124 or writing application IV 128b to security cache 124. This is shown as messages 206 (sending the IV) and message 208 (storing the IV) of FIG. 2.

Security cache 124 is persisted in operation 410. In some examples, operation 410 includes, based on at least receiving an indication of shutting down main VC 110, persisting, by main VC 110, security cache 124. This is shown as message 210 of FIG. 2. Operation 412 includes opening, by the VC (e.g., main VC 110, VC 130a, or VC 130b), a VMCI connection with remote cache validator 152a, and operation 414 includes generating cache IV 154 for security cache 124. Operation 416 includes sending, to cache validator 152a, security cache validation information, which includes cache IV 154 and VC identifier 157 for main VC 110, which is associated with security cache 124. This is shown as message 212 of FIG. 2. The VC verifies that the security cache validation information is registered with cache validator 152a. The VC completes shutting down in operation 418.

FIG. 5 illustrates a flowchart 500 of exemplary operations associated with flowchart 300. In some examples, the operations of flowchart 500 are performed by one or more computing apparatus 1018 of FIG. 10. Flowchart 500 commences with operation 502, which includes receiving, by cache validator 152a, application IV 128a for application 112a or application IV 128b for application 112b. Operation 504 includes storing application IV 128a for application 112a or application IV 128b for application 112b.

Operation 506 includes receiving, by cache validator 152a, security cache validation information, comprising cache IV 154 and VC identifier 157. This is shown as message 212 of FIG. 2. Application validator 152b verifies that the security cache validation information is registered with the VC. Operation 508 includes storing the security cache validation information.

FIG. 6 illustrates a flowchart 600 of exemplary operations associated with flowchart 300. In some examples, the operations of flowchart 600 are performed by one or more computing apparatus 1018 of FIG. 10. Flowchart 600 commences with operation 602, which includes storing the VC (e.g., main VC 110, VC 130a, or VC 130b) in a VC file. In some examples, the VC file comprises a VMDK file. Operation 604 includes encrypting the VC file, either using disk encryption (encrypting an entire volume) or file encryption (encrypting files individually). In some examples, operation 604 is not performed.

Operation 606 includes ongoing monitoring, by cache validator 152a, whether the VC file associated with VC identifier 157 has been modified. A decision operation 608, shown as message 214 in FIG. 2, determines whether the VC file associated with VC identifier 157 has been modified. If so, operation 610 includes, based on at least determining that the VC file associated with VC identifier 157 has been modified identifying the VC file as a dirty file. This may include copying VC identifier 157 into dirty VM registry 158. Otherwise, monitoring remains ongoing in operation 606.

FIG. 7 illustrates a flowchart 700 of exemplary operations associated with flowchart 300. In some examples, the operations of flowchart 700 are performed by one or more computing apparatus 1018 of FIG. 10. Flowchart 700 commences with operation 702, which includes retrieving, by a VC (e.g., main VC 110, VC 130a, or VC 130b), persisted security cache 124. Operation 704 generates cache IV 154 for security cache 124. The VC opens a VMCI connection with cache validator 152a in operation 706. Operation 708 includes sending, to cache validator 152a, cache IV 154 and VC identifier 157 associated with security cache 124. This is indicated as message 218 in FIG. 2. An indication of security cache validity or invalidity is received from cache validator 152a in operation 710, and shown as message 220 in FIG. 2.

Decision operation 712 determines whether, based on the indication received in operation 710, security cache 124 is valid. If not, security cache 124 is discarded in operation 714. Otherwise, operation 716 restores security cache 124 by, based on at least receiving indication of security cache validity, loading security cache 124 into memory. Security cache 124 is then usable for retrieving application IVs 128a and 128b (and also metadata IVs 129a and 129b). This is shown as message 222 in FIG. 2. Flowchart 700 runs two parallel courses through operation 718: the No and Yes branches of decision operation 712.

Operation 718 includes receiving a request to execute application 112a or application 112b on the VC. This is shown as message 224 in FIG. 2. For the No branch of decision operation 712, flowchart 700 moves to operation 720, which includes, based on at least receiving the request to execute application 112a (or application 112b) and receiving the indication of security cache invalidity, generating application IV 128a for application 112a (or generating application IV 128b for application 112b). Operation 722 includes writing application IV 128a or application IV 128b to security cache 124, so that the IV is available for time-saving the next time the same application executes.

For the No branch of decision operation 712, flowchart 700 moves to operation 724 for searching security cache 124 for application IV 128a or application IV 128b. This is shown as message 226 in FIG. 2. Decision operation 726 determines whether the application IV is found in cache 124. If so, operation 728 includes, based on at least receiving the request to execute application 112a (or application 112b) and receiving the indication of security cache validity, retrieving, from security cache 124, application IV 128a (or application IV 128b) for application 112a (or application 112b). Otherwise, flowchart 700 moves to operation 72o to generate the application IV. However, this time, operation 720 includes based on at least receiving the request to execute application 112a (or application 112b) and not locating application IV 128a in security cache 124, generating application IV 128a for application 112a (or generating application IV 128b for application 112b).

A decision operation 730 determines whether the file version of the application (to be executed) is current. If not, operation 732 includes, based on at least determining that the file version of the application is not the current version, blocking the application (e.g., application 112a or 112b) from executing on the VC. Otherwise, if the file version of the application is the current version, operation 734 sends application IV 128a and possibly metadata IV 129a (or application IV 128b and possibly metadata IV 129b) to remote application validator 152b. This is shown as message 228 in FIG. 2. An indication of validity or an indication of invalidity for the application is received from application validator 152b in operation 736. This is shown as message 232 in FIG. 2.

A decision operation 738 determines whether, based on the indication received in operation 736, the application is valid (e.g., safe to execute). If so, operation 740 includes, based on at least receiving the indication of validity for application 112a (or application 112b), permitting application 112a (or application 112b) to execute on the VC. This is shown as message 234 in FIG. 2. Otherwise, if operation 736 returned an invalid result, flowchart 700 moves to operation 732 to block the application. However, this time, operation 732 includes based on at least receiving the indication of invalidity for application 112a (or application 112b), blocking application 112a (or application 112b) from executing on the VC.

FIG. 8 illustrates a flowchart 800 of exemplary operations associated with flowchart 300. In some examples, the operations of flowchart 800 are performed by one or more computing apparatus 1018 of FIG. 10. Flowchart 800 commences with operation 802, which includes receiving, by cache validator 152a, cache IV 154 and VC identifier 157 (e.g., security cache validation information). Decision operation 804 determines whether VC identifier 157 has been registered in registry 156. If not, flowchart 800 moves to fail operation 812, described below.

Otherwise, if VC identifier 157 has been registered in registry 156, decision operation 806 determines whether the VC file (e.g., the file for main VC 110) associated with VC identifier 157 has remained unmodified. In some examples, this includes checking for VC identifier 157 in dirty VM registry. The VC file has not remained unmodified (e.g., the VC file had been changed), flowchart 800 moves to fail operation 812, described below. Otherwise, if the VC file has remained unmodified, decision operation 808 determines whether VC identifier 157 indicates a valid VC (e.g., cache IV 154 is safelisted by having been stored in cache validator 152). If not, flowchart 800 moves to fail operation 812, described below.

If VC identifier 157 does indicates a valid VC (e.g., VC identifier 157 is registered in registry 156, the VC file has remained unmodified, and cache IV 154 is safelisted), operation 810 returns a valid cache indication. That is, operation 810 includes, based on at least determining that VC identifier 157 indicates a valid VC and that cache IV 154 matches a stored IV associated with VC identifier 157, sending, to the VC, the indication of security cache validity. This is shown as message 220 of FIG. 2. Otherwise, operation 812 includes, based on at least determining that VC identifier 157 indicates an invalid VC or that cache IV 154 does not match a stored IV associated with VC identifier 157, sending, to the VC, an indication of security cache invalidity.

Application validator 152b receives application IV 128a or application IV 128b in operation 814. Decision operation 816 determines whether application IV 128a or application IV 128b matches a stored IV. This is shown as message 230 in FIG. 2. In some examples, this also includes determining whether metadata IV 129a or metadata IV 129b matches a stored IV. If so, then operation 818 includes, based on at least determining that application IV 128a (or application IV 128b) matches a stored IV, sending, to the VC, the indication of validity for application 112a (or application 112b). This is shown as message 232 in FIG. 2. Otherwise, operation 820 includes, based on at least determining that application IV 128a (or application IV 128b) does not match a stored IV, sending, to the VC, the indication of invalidity for application 112a (or application 112b).

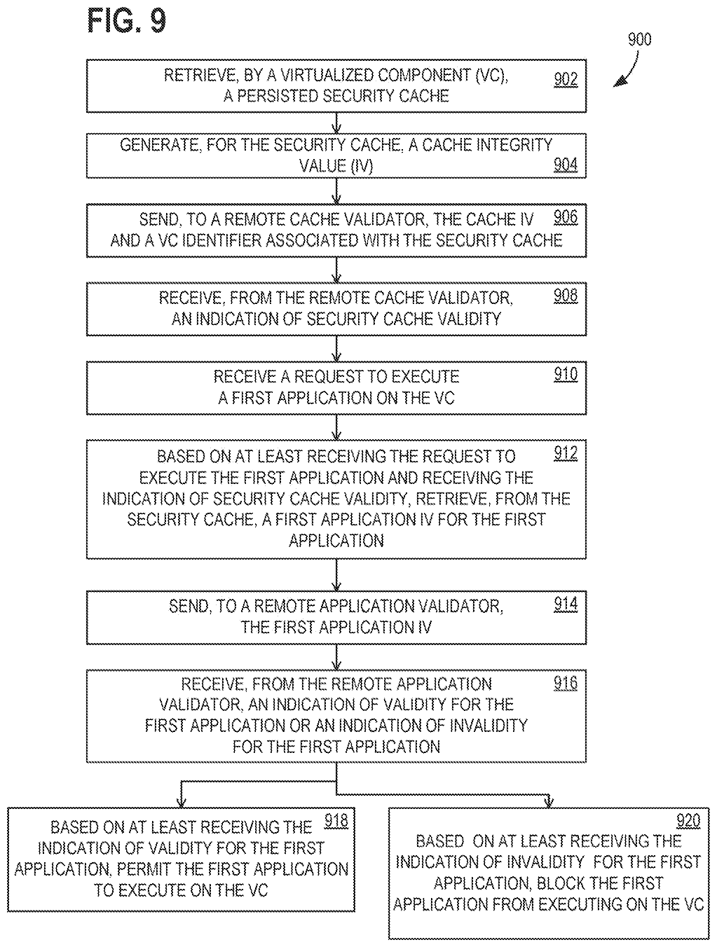

FIG. 9 illustrates a flowchart 900 of exemplary operations that are also associated with architecture 100. In some examples, the operations of flowchart 900 are performed by one or more computing apparatus 1018 of FIG. 10. Flowchart 900 commences with operation 902, which includes retrieving, by a VC, a persisted security cache. Operation 904 includes generating, for the security cache, a cache IV. Operation 906 includes sending, to a remote cache validator, the cache IV and a VC identifier associated with the security cache.

Operation 908 includes receiving, from the remote cache validator, an indication of security cache validity. Operation 910 includes receiving a request to execute a first application on the VC. Operation 912 includes, based on at least receiving the request to execute the first application and receiving the indication of security cache validity, retrieving, from the security cache, a first application IV for the first application. Operation 914 includes sending, to a remote application validator, the first application IV. Operation 916 includes receiving, from the remote application validator, an indication of validity for the first application or an indication of invalidity for the first application. Operation 918 includes, based on at least receiving the indication of validity for the first application, permitting the first application to execute on the VC. Operation 920 includes, based on at least receiving the indication of invalidity for the first application, blocking the first application from executing on the VC.

### Additional Examples

An example method comprises: retrieving, by a VC, a persisted security cache; generating, for the security cache, a cache IV; sending, to a remote cache validator, the cache IV and a VC identifier associated with the security cache; receiving, from the remote cache validator, an indication of security cache validity; receiving a request to execute a first application on the VC; based on at least receiving the request to execute the first application and receiving the indication of security cache validity, retrieving, from the security cache, a first application IV for the first application; sending, to a remote application validator, the first application IV; receiving, from the remote application validator, an indication of validity for the first application or an indication of invalidity for the first application; and based on at least receiving the indication of validity for the first application, permitting the first application to execute on the VC, or based on at least receiving the indication of invalidity for the first application, blocking the first application from executing on the VC.

An example computer system comprises: a processor; and a non-transitory computer readable medium having stored thereon program code executable by the processor, the program code causing the processor to: retrieve, by a VC, a persisted security cache; generate, for the security cache, a cache IV; send, to a remote cache validator, the cache IV and a VC identifier associated with the security cache; receive, from the remote cache validator, an indication of security cache validity; receive a request to execute a first application on the VC; based on at least receiving the request to execute the first application and receiving the indication of security cache validity, retrieve, from the security cache, a first application IV for the first application; send, to a remote application validator, the first application IV; receive, from the remote application validator, an indication of validity for the first application or an indication of invalidity for the first application; and based on at least receiving the indication of validity for the first application, permit the first application to execute on the VC, or based on at least receiving the indication of invalidity for the first application, block the first application from executing on the VC.

An example non-transitory computer storage medium has stored thereon program code executable by a processor, the program code embodying a method comprising: retrieving, by a VC, a persisted security cache; generating, for the security cache, a cache IV; sending, to a remote cache validator, the cache IV and a VC identifier associated with the security cache; receiving, from the remote cache validator, an indication of security cache validity; receiving a request to execute a first application on the VC; based on at least receiving the request to execute the first application and receiving the indication of security cache validity, retrieving, from the security cache, a first application IV for the first application; sending, to a remote application validator, the first application IV; receiving, from the remote application validator, an indication of validity for the first application or an indication of invalidity for the first application; and based on at least receiving the indication of validity for the first application, permitting the first application to execute on the VC, or based on at least receiving the indication of invalidity for the first application, blocking the first application from executing on the VC.

Alternatively, or in addition to the other examples described herein, examples include any combination of the following:
the VC comprises a clone of a base object;
the VC comprises a base object planned for cloning;
opening, by the VC, a VMCI connection with the remote application validator;
a remote validator comprises the remote cache validator and the remote application validator;
generating the first application IV for the first application;
generating the second application IV for the second application;
the IV comprises a hash value;
the hash value comprises a SHA family hash value;
the SHA family hash value comprises a SHA-256 hash value;
the IV comprises a checksum;
generating the first application IV for the first application comprises generating an IV for metadata of the first application;
generating the second application IV for the second application comprises generating an IV for metadata of the second application;
generating an application IV comprises generating a single IV using both the application and the metadata for the application;
generating an application IV comprises generating two IVs, in which a first IV is generated for the application and a second IV is generated for the metadata for the application;
the metadata for the application comprises a path of an executable file of the application;
the metadata for the application comprises attributes of the executable file of the application;
writing the first application IV to the security cache;
writing the second application IV to the security cache;
registering, with the remote application validator, the first application IV for the first application and the second application IV for the second application;
the VC verifies the security cache validation information is registered with the remote application validator;
persisting, by the main VC, the security cache;
based on at least receiving an indication of shutting down the main VC, persisting, by the main VC, the security cache;
generating the cache IV for the security cache;
sending, to the remote cache validator, security cache validation information;
the security cache validation information comprises the cache IV and a VC identifier associated with the security cache;
the identifier comprises a unique identifier;
the identifier comprises a UUID;
the identifier comprises 128-bits;
the VC verifies the security cache validation information is registered with the remote cache validator;
receiving, by the remote cache validator, the first application IV for the first application;
receiving, by the remote cache validator, the second application IV for the second application;
storing the first application IV for the first application;
storing the second application IV for the second application;
the remote application validator verifies the security cache validation information is registered with the VC;
receiving, by the remote cache validator, security cache validation information;
the security cache validation information comprises the cache IV and a VC identifier associated with the security cache;
the remote cache validator verifies the security cache validation information is registered with the VC;
storing the VC in a VC file;
the VC file comprises a VMDK file;
encrypting the VC file;
monitoring, by the remote cache validator, whether the VC file associated with the VC identifier has been modified;
based on at least determining that the VC file associated with the VC identifier has been modified, identifying the VC file as a dirty file;
generating the VC from a base object;
opening, by the VC, a VMCI connection with the remote cache validator;
registering the security cache validation information with the remote cache validator;
sending, to the remote cache validator, the cache IV and a VC identifier associated with the security cache;
receiving, by the remote cache validator, the cache IV and the VC identifier;
determining whether the cache IV matches a stored IV associated with the VC identifier;
determining whether the VC identifier has been registered;
determining whether a VC file associated with the VC identifier has remained unmodified;
determining whether the cache IV matches a stored IV associated with the VC identifier;
determining whether the VC identifier indicates a valid VC comprises determining whether the VC identifier matches a safelisted IV;
based on at least determining that the VC identifier indicates a valid VC and that the cache IV matches a stored IV associated with the VC identifier, sending, to the VC, the indication of security cache validity;
based on at least determining that the VC identifier indicates an invalid VC or that the cache IV does not match a stored IV associated with the VC identifier, sending, to the VC, an indication of security cache invalidity;
receiving, from the remote cache validator, an indication of security cache invalidity;
prior to retrieving, by the VC, the persisted security cache, receiving a request to execute a first application on the VC;
prior to retrieving, by the VC, the persisted security cache, receiving a request to execute a second application on the VC;
based on at least receiving the request to execute the first application and receiving the indication of security cache invalidity, generating the first application IV for the first application;
based on at least receiving the request to execute the second application and receiving the indication of security cache invalidity, generating the second application IV for the second application;
receiving, from the remote cache validator, an indication of security cache validity;
based on at least receiving indication of security cache validity, loading the security cache into memory for retrieving IVs;
based on at least receiving the request to execute the first application, determining whether a file version of the first application is the current version;
based on at least receiving the request to execute the second application, determining whether a file version of the second application is the current version;
based on at least determining that the file version of the first application is not the current version, blocking the first application from executing on the VC;
based on at least determining that the file version of the second application is not the current version, blocking the second application from executing on the VC;
searching for the first application IV in the security cache;
searching for the second application IV in the security cache;
based on at least receiving the request to execute the first application and receiving the indication of security cache validity, retrieving, from the security cache, a first application IV for the first application;
based on at least receiving the request to execute the second application and receiving the indication of security cache validity, retrieving, from the security cache, a second application IV for the second application;
based on at least receiving the request to execute the first application and not locating the first application IV in the security cache, generating the first application IV for the first application;
based on at least receiving the request to execute the second application and not locating the second application IV in the security cache, generating the second application IV for the second application;
sending, to a remote application validator, the first application IV;
sending, to the remote application validator, the second application IV;
receiving, by the remote application validator, the first application IV;
receiving, by the remote application validator, the second application IV;
determining, by the remote application validator, whether the first application IV matches a stored IV;
determining, by the remote application validator, whether the second application IV matches a stored IV;
based on at least determining that the first application IV matches a stored IV, sending, to the VC, the indication of validity for the first application;
based on at least determining that the second application IV matches a stored IV, sending, to the VC, the indication of validity for the second application;
based on at least determining that the first application IV does not match a stored IV, sending, to the VC, the indication of invalidity for the first application;
based on at least determining that the second application IV does not match a stored IV, sending, to the VC, the indication of invalidity for the second application;
receiving, from the remote application validator, an indication of validity for the first application or an indication of invalidity for the first application;
receiving, from the remote application validator, an indication of validity for the second application or an indication of invalidity for the second application;
based on at least receiving the indication of validity for the first application, permitting the first application to execute on the VC;
based on at least receiving the indication of validity for the second application, permitting the second application to execute on the VC;
based on at least receiving the indication of invalidity for the first application, blocking the first application from executing on the VC; and
based on at least receiving the indication of invalidity for the second application, blocking the second application from executing on the VC.

### Exemplary Operating Environment

The present disclosure is operable with a computing device (computing apparatus) according to an embodiment shown as a functional block diagram 1000 in FIG. 10. In an embodiment, components of a computing apparatus 1018 may be implemented as part of an electronic device according to one or more embodiments described in this specification. The computing apparatus 1018 comprises one or more processors 1019 which may be microprocessors, controllers, or any other suitable type of processors for processing computer executable instructions to control the operation of the electronic device. Alternatively, or in addition, the processor 1019 is any technology capable of executing logic or instructions, such as a hardcoded machine. Platform software comprising an operating system 1020 or any other suitable platform software may be provided on the computing apparatus 1018 to enable application software 1021 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1018. Computer-readable media may include, for example, computer storage media such as a memory 1022 and communications media. Computer storage media, such as a memory 1022, include volatile and non-volatile, removable, and non-removable media implemented in any method or technology for storage of information such as computer readable instructions, data structures, program modules or the like. In some examples, computer storage media are implemented in hardware. Computer storage media include, but are not limited to, RAM, ROM, EPROM, EEPROM, persistent memory, non-volatile memory, phase change memory, flash memory or other memory technology, compact disc (CD, CD-ROM), digital versatile disks (DVD) or other optical storage, floppy drives, hard disks, magnetic cassettes, magnetic tape, magnetic disk storage, shingled disk storage or other magnetic storage devices, or any other non-transmission medium that can be used to store information for access by a computing apparatus. Computer storage media are tangible, non-transitory, and are mutually exclusive to communication media.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1022) is shown within the computing apparatus 1018, it will be appreciated by a person skilled in the art, that the storage may be distributed or located remotely and accessed via a network or other communication link (e.g. using a communication interface 1023).

The computing apparatus 1018 may comprise an input/output controller 1024 configured to output information to one or more output devices 1025, for example a display or a speaker, which may be separate from or integral to the electronic device. The input/output controller 1024 may also be configured to receive and process an input from one or more input devices 1026, for example, a keyboard, a microphone, or a touchpad. In one embodiment, the output device 1025 may also act as the input device. An example of such a device may be a touch sensitive display. The input/output controller 1024 may also output data to devices other than the output device, e.g. a locally connected printing device. In some embodiments, a user may provide input to the input device(s) 1026 and/or receive output from the output device(s) 1025.

The functionality described herein can be performed, at least in part, by one or more hardware logic components. According to an embodiment, the computing apparatus 1018 is configured by the program code when executed by the processor 1019 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
retrieving, by a virtualized component (VC), a persisted security cache;
generating, for the security cache, a cache integrity value (IV);
sending, to a remote cache validator, the cache IV and a VC identifier associated with the security cache;
receiving, from the remote cache validator, an indication of security cache validity;
receiving a request to execute a first application on the VC;
based on at least receiving the request to execute the first application and receiving the indication of security cache validity, retrieving, from the security cache, a first application IV for the first application;
sending, to a remote application validator, the first application IV;
receiving, from the remote application validator, an indication of validity for the first application or an indication of invalidity for the first application;
based on at least receiving the indication of validity for the first application, permitting the first application to execute on the VC; and
based on at least receiving the indication of invalidity for the first application, blocking the first application from executing on the VC.

2. The method of claim 1, wherein the VC comprises a virtual machine (VM) or a container, and wherein the IV comprises a hash value.

3. The method of claim 1, further comprising:
receiving a request to execute a second application on the VC;
based on at least receiving the request to execute the second application and receiving the indication of security cache validity, retrieving, from the security cache, a second application IV for the second application;
sending, to the remote application validator, the second application IV;
receiving, from the remote application validator, an indication of validity for the second application or an indication of invalidity for the second application;
based on at least receiving the indication of validity for the second application, permitting the second application to execute on the VC; and
based on at least receiving the indication of invalidity for the second application, blocking the second application from executing on the VC.

4. The method of claim 1, further comprising:
receiving, by the remote cache validator, the cache IV and the VC identifier;
determining that the VC identifier indicates a valid VC and determining that the cache IV matches a stored IV associated with the VC identifier;
sending, to the VC, the indication of security cache validity;
receiving, by the remote application validator, the first application IV;
determining, by the remote application validator, that the first application IV matches a stored IV; and
sending, to the VC, the indication of validity for the first application.

5. The method of claim 4, wherein determining that the VC identifier indicates a valid VC comprises:
determining that the VC identifier has been registered; and
determining that a VC file associated with the VC identifier has remained unmodified.

6. The method of claim 1, further comprising:
prior to retrieving, by the VC, the persisted security cache:
receiving a request to execute the first application on a main VC;
generating the first application IV for the first application;
writing the first application IV to the security cache; and
based on at least receiving an indication of shutting down the main VC, persisting, by the main VC, the security cache.

7. The method of claim 1, wherein a remote validator comprises the remote cache validator and the remote application validator.

8. A computer system comprising:
a processor; and
a non-transitory computer readable medium having stored thereon program code executable by the processor, the program code causing the processor to:
retrieve, by a virtualized component (VC), a persisted security cache;
generate, for the security cache, a cache integrity value (IV);
send, to a remote cache validator, the cache IV and a VC identifier associated with the security cache;
receive, from the remote cache validator, an indication of security cache validity;
receive a request to execute a first application on the VC;
based on at least receiving the request to execute the first application and receiving the indication of security cache validity, retrieve, from the security cache, a first application IV for the first application;
send, to a remote application validator, the first application IV;
receive, from the remote application validator, an indication of validity for the first application or an indication of invalidity for the first application;
based on at least receiving the indication of validity for the first application, permit the first application to execute on the VC; and
based on at least receiving the indication of invalidity for the first application, block the first application from executing on the VC.

9. The computer system of claim 8, wherein the VC comprises a virtual machine (VM) or a container, and wherein the IV comprises a hash value.

10. The computer system of claim 8, wherein the program code is further operative to:
receive a request to execute a second application on the VC;
based on at least receiving the request to execute the second application and receiving the indication of security cache validity, retrieve, from the security cache, a second application IV for the second application;
send, to the remote application validator, the second application IV;
receive, from the remote application validator, an indication of validity for the second application or an indication of invalidity for the second application;
based on at least receiving the indication of validity for the second application, permit the second application to execute on the VC; and
based on at least receiving the indication of invalidity for the second application, block the second application from executing on the VC.

11. The computer system of claim 8, wherein the program code is further operative to:
receive, by the remote cache validator, the cache IV and the VC identifier;
determine that the VC identifier indicates a valid VC and determine that the cache IV matches a stored IV associated with the VC identifier;
send, to the VC, the indication of security cache validity;
receive, by the remote application validator, the first application IV;
determine, by the remote application validator, that the first application IV matches a stored IV; and
send, to the VC, the indication of validity for the first application.

12. The computer system of claim 11, wherein determining whether the VC identifier indicates a valid VC comprises:
determining that the VC identifier has been registered; and
determining that a VC file associated with the VC identifier has remained unmodified.

13. The computer system of claim 8, wherein the program code is further operative to:
prior to retrieving, by the VC, the persisted security cache:
receive a request to execute the first application on a main VC;
generate the first application IV for the first application;
write the first application IV to the security cache; and
based on at least receiving an indication of shutting down the main VC, persist, by the main VC, the security cache.

14. The computer system of claim 8, wherein a remote validator comprises the remote cache validator and the remote application validator.

15. A non-transitory computer storage medium having stored thereon program code executable by a processor, the program code embodying a method comprising:
retrieving, by a virtualized component (VC), a persisted security cache;
generating, for the security cache, a cache integrity value (IV);
sending, to a remote cache validator, the cache IV and a VC identifier associated with the security cache;
receiving, from the remote cache validator, an indication of security cache validity;
receiving a request to execute a first application on the VC;
based on at least receiving the request to execute the first application and receiving the indication of security cache validity, retrieving, from the security cache, a first application IV for the first application;
sending, to a remote application validator, the first application IV;
receiving, from the remote application validator, an indication of validity for the first application or an indication of invalidity for the first application;
based on at least receiving the indication of validity for the first application, permitting the first application to execute on the VC; and
based on at least receiving the indication of invalidity for the first application, blocking the first application from executing on the VC.

16. The computer storage medium of claim 15, wherein the VC comprises a virtual machine (VM) or a container, and wherein the IV comprises a hash value.

17. The computer storage medium of claim 15, wherein the program code further comprises:
receiving a request to execute a second application on the VC;
based on at least receiving the request to execute the second application and receiving the indication of security cache validity, retrieving, from the security cache, a second application IV for the second application;
sending, to the remote application validator, the second application IV;
receiving, from the remote application validator, an indication of validity for the second application or an indication of invalidity for the second application;
based on at least receiving the indication of validity for the second application, permitting the second application to execute on the VC; and
based on at least receiving the indication of invalidity for the second application, blocking the second application from executing on the VC.

18. The computer storage medium of claim 15, wherein the program code further comprises:
receiving, by the remote cache validator, the cache IV and the VC identifier;
determining that the VC identifier indicates a valid VC and determining that the cache IV matches a stored IV associated with the VC identifier;
sending, to the VC, the indication of security cache validity;
receiving, by the remote application validator, the first application IV;
determining, by the remote application validator, that the first application IV matches a stored IV; and
sending, to the VC, the indication of validity for the first application.

19. The computer storage medium of claim 18, wherein determining whether the VC identifier indicates a valid VC comprises:
determining that the VC identifier has been registered; and
determining that a VC file associated with the VC identifier has remained unmodified.

20. The computer storage medium of claim 15, wherein the program code further comprises:
prior to retrieving, by the VC, the persisted security cache:
receiving a request to execute the first application on a main VC;
generating the first application IV for the first application;
writing the first application IV to the security cache; and
based on at least receiving an indication of shutting down the main VC, persisting, by the main VC, the security cache.
